(19) United States
(12) Patent Application Publication
(10) Pub. No.: US 2015/0039347 A1
(43) Pub. Date: Feb. 5, 2015

(54) SYSTEMS AND METHODS FOR PROVIDING PROACTIVE MONITORING, INTERVENTION, AND INSURANCE COVERAGE SERVICES IN A PACKAGE DELIVERY NETWORK

(71) Applicant: United Parcel Service of America, Inc., Atlanta, GA (US)

(72) Inventor: Kranti Sharma, Roswell, GA (US)

(73) Assignee: United Parcel Service of America, Inc., Atlanta, GA (US)

(21) Appl. No.: 13/957,542

(22) Filed: Aug. 2, 2013

(51) Int. Cl. G06Q 10/08

(52) U.S. Cl. CPC G06Q 10/0833; G06Q 40/08
USPC 705/4

(57) ABSTRACT

Various embodiments provide a system for proactively managing intervention activities associated with the delivery of at least one package and the settlement of costs incurred thereby. The system comprises one or more computer processors configured to receive new PLD data, the new PLD comprising at least an indication of a jeopardy delivery condition triggering the predefined condition associated with and impacting the delivery of the at least one package; determine and identify one of the one or more actions to be taken by the service provider in response to the jeopardy delivery condition, the determination and identification being based at least in part upon a portion of the intervention data; receive an indication of costs incurred due to the identified action being taken; and in response to receiving the indication, determine an appropriate settlement procedure for the costs, the determination being based at least in part upon the insurance data.

### BACKGROUND OF VARIOUS EMBODIMENTS

1. Description of Related Field

Various embodiments of the invention generally pertain to proactively monitoring the delivery of a package by a package delivery service provider, including intervening in certain circumstances and providing associated coverage for costs incurred at in part as a result of any activities associated with intervening.

2. Description of Related Art

In the package delivery context, a variety of services can be provided to the originator of a package (called the consignor) and the recipient of the package (called the consignee). The package delivery service provider (also called the carrier) may provide various service levels, and ancillary services, such as notification of delivery and special handling processing.

For example, U.S. Pat. No. 6,539,360 provides that special instructions for handling a package can be conveyed, including holding the package for pickup by the consignee at a certain location. Further, status and limited notification capabilities can be defined to inform a user when a delivery is expected to occur. However, the capabilities are somewhat limited, not only with respect to providing collaborative information sharing and resolution, but also with available resolution (e.g., intervening) activities and the management of the costs associated therewith.

### BRIEF SUMMARY

According to various embodiments of the present invention, a system for proactively managing intervention activities associated with the delivery of at least one package and the settlement of costs incurred thereby is provided. The system comprises: one or more memory storage areas containing: customer profile data comprising customer contact data for a customer associated with the delivery of the at least one package, intervention data regarding one or more actions to be taken by a service provider in response to a predefined condition associated with delivery of the at least one package, and insurance data regarding coverage of costs that may be incurred should the one or more actions be taken in response to the predefined condition; proactive monitoring data including information regarding status of the at least one package; and package level detail (“PLD”) data comprising a carrier tracking number of the package, and a proactive response secure (“PRS”) indication associated with the package. The system further comprises one or more computer processors configured to: receive new PLD data, the new PLD comprising at least an indication of a jeopardy delivery condition triggering the predefined condition associated with and impacting the delivery of the at least one package; determine and identify one of the one or more actions to be taken by the service provider in response to the jeopardy delivery condition, the determination and identification being based at least in part upon a portion of the intervention data; receive an indication of costs incurred due to the identified action being taken by the service provider; and in response to receiving the indication of costs incurred, determine an appropriate settlement procedure for the costs, the determination being based at least in part upon the insurance data.

According to various embodiments of the present invention, a computer-implemented method for proactively managing intervention activities associated with the delivery of at least one package and the settlement of costs incurred thereby is provided. The method comprises the step of receiving and storing within one or more memory storage areas: customer profile data comprising customer contact data for a customer associated with the delivery of the at least one package, intervention data regarding one or more actions to be taken by a service provider in response to a predefined condition associated with delivery of the at least one package, and insurance data regarding coverage of costs that may be incurred should the one or more actions be taken in response to the predefined condition; proactive monitoring data including information regarding status of the at least one package; and package level detail (“PLD”) data comprising a carrier tracking number of the package, and a proactive response secure (“PRS”) indication associated with the package. The method further comprises the steps of: receiving new PLD data, the new PLD comprising at least an indication of a jeopardy delivery condition triggering the predefined condition associated with and impacting the delivery of the at least one package; determining and identifying one of the one or more actions to be taken by the service provider in response to the jeopardy delivery condition, the determination and identification being based at least in part upon a portion of the intervention data; receiving an indication of costs incurred due to the identified action being taken by the service provider; and in response to receiving the indication of costs incurred, determining an appropriate settlement procedure for the costs, the determination being based at least in part upon the insurance data.

According to various embodiments of the present invention, a non-transitory computer program product comprising at least one computer-readable storage medium having computer-readable program code portions embodied therein is provided. The computer-readable program code portions comprise: a first executable portion configured for receiving a plurality of data, wherein the data comprises: customer profile data comprising customer contact data for a customer associated with the delivery of the at least one package, intervention data regarding one or more actions to be taken by a service provider in response to a predefined condition associated with delivery of the at least one package, and insurance data regarding coverage of costs that may be incurred should the one or more actions be taken in response to the predefined condition; proactive monitoring data including information regarding status of the at least one package; and package level detail (“PLD”) data comprising a carrier tracking number of the package, a proactive response secure (“PRS”) indication associated with the package, and an indication of a jeopardy delivery condition triggering the predefined condition associated with and impacting the delivery of the at least one package. The computer-readable program code portions further comprise: a second executable portion configured for determining and identifying one of the one or more actions to be taken by the service provider in response to the jeopardy delivery condition, the determination and identification being based at least in part upon a portion of the intervention data; and a third executable portion configured for: (i) receiving an indication of costs incurred due to the identified action being taken by the service provider; and (ii) in response to receiving the indication of costs incurred, determining an appropriate settlement procedure for the costs, the determination being based at least in part upon the insurance data.

### BRIEF DESCRIPTION OF THE SEVERAL VIEWS OF THE DRAWING(S)

Reference will now be made to the accompanying drawings, which are not necessarily drawn to scale, and wherein:

FIG. 1 illustrates an exemplary process flow of steps involved in providing proactive monitoring and intervention in conjunction with the delivery of a package according to various embodiments, as may be provided in certain embodiments via the PR module 530 of FIG. 5;

FIG. 2 illustrates the relationship of a customer profile and case log with various entities according to various embodiments;

FIG. 3 illustrates the various functions associated with case log management of the present invention potentially available to a customer service representative according to various embodiments;

FIG. 4 illustrates various entities involved with a system accomplishing proactive monitoring and intervention, particularly illustrating a proactive response (“PR”) management information system (“MIS) 410 according to various embodiments;

FIG. 5 illustrates a schematic block diagram of a proactive response secure (“PRS”) management information system (“MIS”) 510 according to various embodiments;

FIG. 6 illustrates a schematic diagram of various databases that are utilized by the PRS MIS 510 shown in FIG. 5 according to various embodiments;

FIG. 7 illustrates an exemplary process flow according to various embodiments for the data module 520 shown in FIGS. 5 and 6;

FIG. 8 illustrates an exemplary process flow according to various embodiments for the data module 540 shown in FIGS. 5 and 6;

FIG. 9 illustrates an exemplary process flow according to various embodiments for the notification module 550 shown in FIGS. 5 and 6; and

FIG. 10 illustrates exemplary process flows for submittal of a PRS claim under certain circumstances, as may be encountered according various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Certain types of packages conveyed by a package delivery service (“carrier”) are extremely time sensitive or otherwise require special handling, and thus require additional steps to ensure that packages are delivered within a certain time frame and in a certain condition. In such cases, merely providing tracking information and ‘visibility’ as to the status of the package, using presently offered information tools, is not sufficient to meet the customer's needs. In many cases, a more involved interaction is required between various parties, typically including the consignor, but potentially also including the consignee, the carrier, and in some cases, a third party to ensure that the package is delivered according to the needs of the customer.

The prior art provided reporting of information, but in various embodiments of the present invention, the information exchange is more of a collaboration or interactive information exchange. The prior art systems provide information about a package's status to a user, and in some cases may allow a user to select options associated with its delivery, but this is not sufficient for handling an exceptional case. An “exceptional” case or “exception,” is any situation that deviates from the normal, anticipated delivery of a package. While most of the delivery instances are not exceptional, in certain instances, deviations from the expected or desired handling are required. Because such instances are by definition, special cases, they are called “exceptions.” Such exceptions represent any infinite number of possible occurrences, which by their nature cannot always be categorized or addressed by applying a predefined or set action.

One such industry segment having critical delivery requirements includes the healthcare industry. Such packages typically have a very high value to the consignee or other parties, and could contain, for example: medications or surgical supplies, including human tissue samples. Other examples include delivery of perishable item or commodities, delivery of high valued items, and delivery of hazardous material. In such instances, merely providing tracking information (e.g., “shipping status”) in response to a user entering tracking information at web site, for example, is not sufficient to fully apprise the user of the situation associated with the delivery of the good. In many prior art systems, the user is required to proactively monitor the status, which may not always be practical. Other systems have the capability to issue a notification to a designated recipient, but such systems may not be flexible enough to allow interaction with a user. For example, some system may provide an email notification regarding the status of a package, but because such emails are generated from automated systems, any response by the recipient is of little value, and likely to be ignored.

Although various embodiments of the present invention are disclosed in terms of delivering packages and package carriers, the various embodiments applied to delivery of freight and goods, regardless of its classification as a parcel, package, container, truckload, pallet, or other indication. Further, the principles of various embodiments can apply to a package delivery provider, freight forwarded, trucking company, courier, or any other designation used to refer to a provider or transporter of goods. Further, the provider of goods is not restricted to a public carrier, but could be a value added coordinator of goods, which potentially contracts out to carriers of various sorts to provide various transport services.

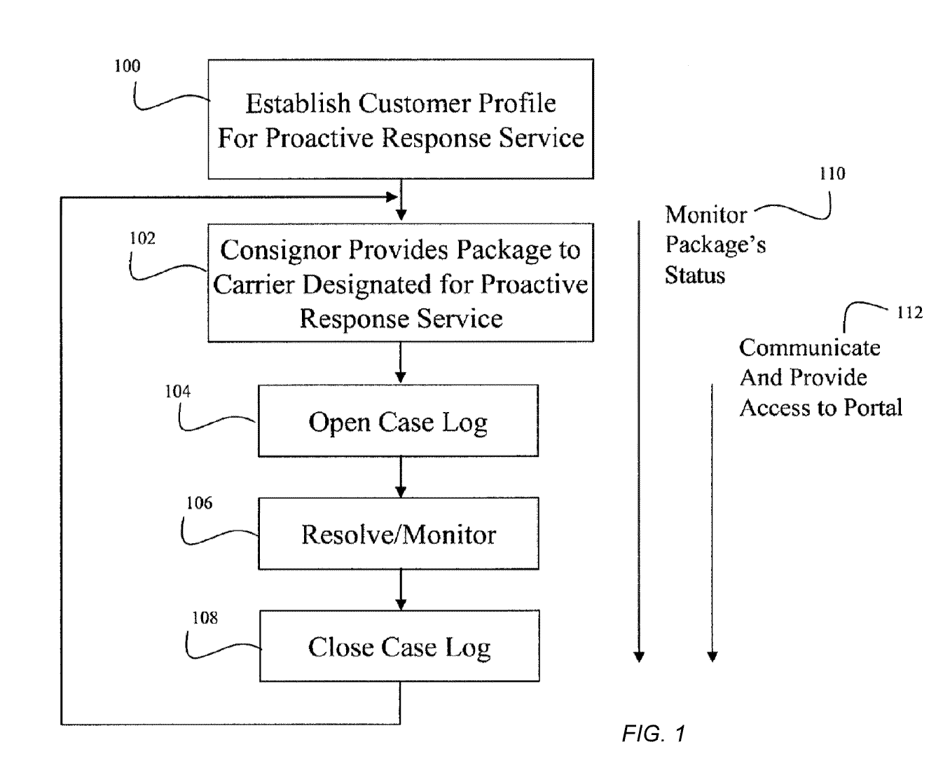

Various embodiments of the present invention overcome the disadvantages of the prior art by maintaining a portal—e.g., information gateway, allowing information to be reviewed, interrogated, presented, and responded to between various parties, thus allowing interaction between a customer and a customer service representative (“CSR”). A high level overview of the general process according to various embodiments is shown in FIG. 1. Additional details in this regard may also be found within U.S. Pat. No. 8,489,472, the contents of which are incorporated by reference herein in their entirety.

In FIG. 1, the customer first establishes a profile in step 100. In a preferred embodiment, the customer is the consignor. However, other embodiments are contemplated in which the customer is the consignee, agent of the consignor or consignee, or even a third party. Typically, the consignee is the most interested in the delivery of the package, as opposed to the consignor, but in many business interactions, the consignor is involved if there is an exception occurring in the delivery. Usually, the carrier contracts with the consignor for the carriage of the goods, not the consignee. A third party, who may be the ultimate user of the goods, may also be involved.

Each customer profile maintains information associated with that customer, including a series of contact names, contact information (including, but not limited to, email address, telephone number, pager number, fax number, etc.), criteria information, customer number, etc. This information is above and beyond what is typically required by a customer in establishing an account with the carrier, although some of the information may be repeated. For example, the customer number assigned by the carrier can be used to reference the customer's profile. Further, a series of customer numbers may be linked together in a common profile (such as when a corporate entity having multiple shipping departments, such as on a campus, is consolidated under a common customer profile. Once the profile is established, the carrier has sufficient information to ensure that the customer can be contacted and provided access to a portal with information on a particular shipment. Typically, the customer profile is established once, and is a necessary prerequisite to operation of the service. While customer profiles are known in the prior art, this customer profile contains information for the purpose of managing certain shipments, designated as “PR packages” (e.g., packages indicated as receiving proactive response (e.g., monitoring & intervention service) treatment.)

The next step occurs in step 102, where the consignor provides a package to the carrier which is designed as a PR package. Packages are typically specifically designated as requiring PR, and such designations may be used to bill the customer for the additional service level and to discriminate the additional services provided to the PR package. The customer may be charged for this service on a per-package basis, a flat rate (regardless of the number of packages), or some other way. The PR indication is typically conveyed from the consignor to the carrier using a shipping system, which the consignor uses to indicate parcel level detail (PLD) information, including the consignor's address, the consignee's address, class of service, weight, and other information associated with shipping a package. The PR may be considered as an accessorial indication or a class of service indication, and typically would apply to a high priority class of service, for example, next day air delivery service, or second day delivery service. There can be a number of PR indication codes, which provide some high level information regarding certain common conditions concerning the temperature of the shipment. These codes could indicate the nature of the contents (e.g., “medical supplies”), or other attendant conditions (e.g., “must be maintained below 90 degrees Fahrenheit at all times”). In other embodiments, there may be a series of code (e.g., indicating contents and conditions separately). In other embodiments, the user may be able to provide user-defined text information.

The PR indication is conveyed with the PLD information from the consignor to the carrier' systems and the carrier will typically store this indication in conjunction with the PLD information in various database systems. Typically, the PLD database maintains records in a database that are indexed using a package tracking number. In this manner, the carrier has enough information so that when given the package tracking number, the carrier can then identify the customer profile, should the information contained therein be required.

The next step 104 involves opening a “case log”, which is information associated with a particular package. At this point, an implementation option exists as to whether the case log is opened for every PR indicated package, or for only PR indicated packages which are, or expected to undergo, problems in their delivery. In the preferred embodiment, a case log is created only when information indicating an “at risk” incident is identified. This approach may minimize the data storage requirements and only store data when exception conditions are noted.

It is possible in the former instance to open a case log for every package that is indicated as being associated with the PR service. In the case where the package is delivered as expected, the case log will contain minimal information, and could duplicate the scanning and tracking information found in regular package handling tracking databases. An alternative implementation would be to track the scanning and tracking information as in regular package databases, and simply record a flag in the PLD database indicating that the package is associated with the PR service. As will be discussed later, the carrier's systems will proactively monitor PR-associated packages to determine whether a problem for a particular PR indicate package develops, or has developed. In cases where no problem has developed with respect to a PR indicated package, the exception handling procedures associated with the PR service do not come into play. A package which is, or may be subject to a condition adversely impacting its delivery can be called a package in “jeopardy.” Explicit “jeopardy” indicates may be defined in the PLD database or case logs that flag such packages are requiring exceptional handling. Consequently, most of the embodiments disclosed herein focus on instances where exceptional handling is required.

If exception handling is required, then a case log is opened. The case log is the logical collection of information associated with the disposition and status of the package that can be accessed by various parties. The information retained is focused on not only the status, but other information associated with handling and communicating of information between the various parties. The case log may be implemented in various ways, including linking related sets of information, and does not necessary imply a particular implementation or storage arrangement.

The next step, indicated in step 106, involves the resolution of the current or potential problem (e.g., jeopardy situation) associated with the delivery of the package and monitoring of the package. At this stage, status information is logged, instructions from customer service representatives (CSRs) are recorded, and access to the information is provided to relevant parties.

Finally, in step 108, the case log is closed, which typically occurs when the package has been successfully delivered. Typically, once the package is delivered, additional status and information is no longer recorded, and the log can be archived. Such case logs can be subsequently retrieved and used in generating reports.

The process then repeats by returning to step 102, in which the customer provides another package associated with the PR service. This loop essentially continues for each package provided by the customer that is associated with PR service, for as long as that customer is a subscriber to PR.

After a package is provided by the customer (e.g., starting with step 102), various carrier systems will monitor and track the package, as indicated by arrow 110. The monitor and tracking occurs systematically, that is, by various automated systems that scan, trace, and report PLD information as part of the normal, automated sorting of packages at the various points along the carrier's routing of the package. These systems track the PR package using the same infrastructure (e.g., bar code readers, RFI tag readers, etc.) that are used with non-PR packages, but the data received is correlated with a particular package (as identified by the bar code or package tracking number) and identified as being associated with the PR service, or in other words, identified as a PR package. The PR systems will record a flag based on any information that indicates or suggests that a PR package is in jeopardy, which means either an actual or potential problem.

The “problem” (or service affecting condition) can be varied, and is not limited to the embodiments listed herein. Several common problems include 1) a time-delivery sensitive package which is not on schedule, 2) a temperature sensitive package which is not within the specified temperature range (or in an environment which is outside the required temperature range), or 3) a package which has exhibited damage, which threatens the integrity of the contents (e.g., a leaking contents).

Other service affecting conditions detection of a missing anticipated load scan. For example, when a package enters a sorting facility, it is normally scanned and routed appropriately, which may include transloading the package from one vehicle to another. Since a package may be scanned when off-loaded, it is expected that another scan would be encountered to load it onto the next segment of its route. Any exceptions noted can be checked to determine whether the particular package is associated with PR service. Further, the scan information can be compared against an anticipated scheduled—e.g., given a starting date for conveying the package with a known route, it is expected the package should be scanned at certain points along that route at certain times. Again, detecting an anomaly condition based on date can also trigger action. Other information includes other anomaly such as incomplete or inconsistent scan information (e.g., zip code information is not matched with a destination address, etc.).

In summary, the service affecting conditions can be reactive or proactive in nature. Because there are a wide number of potential service affecting conditions, various embodiments of the present invention are intended to accommodate a variety of problems. Because there are numerous customer-specific requirements that cannot be anticipated in each and every case, various embodiments of the present invention provide the infrastructure for accommodating these various situations, without having to define in advance, each type of condition. Thus, as additional conditions are identified, they can be incorporated into the framework of various embodiments of the present invention.

The monitoring of problems may be first reported by automated system, but it can also occur, and be reported, by human intervention. Human reporting can occur by various types of carrier personnel, including: delivery vehicle drivers, sorting personnel, customer service representatives. These individuals can report problems based on their own observations (e.g., a delivery or operations personnel notices a PR package is damaged and leaking contents). Or, operations personnel may note a potential issue, and report information to the Case Log associated with the package, or contact a CSR involved with PR packages. Alternatively, the customer (typically the consignor) can initiate a report (e.g., the package needs to be returned to consignor immediately—e.g., “intercepted”). In many situations, multiple individuals (e.g., different customer service individuals or different individuals associated with the customer) may be reporting or updating information in the case log. When a customer service representative notes an exception associated with the package record, this typically automatically generates a case log if it is associated with a PR package.

The reporting typically occurs via the individuals providing information either to a CSR via telephone contact, or information via computer to a portal (e.g., a web site). Regardless of how the information is collected, eventually the information is recorded in the appropriate case log, so that information can be readily accessed by various individuals when needing to know the status of a particular package.

Once the case log is created, the information is stored (logically) in the PR database (e.g., “portal”) which can be communicated and accessed by various individuals. As shown by the arrow 112 in FIG. 1, once created, the portal is designed to be a central clearinghouse of information to facilitate resolution of the any service affecting issues. The portal allows recording and posting of various information, including times of where the package has been scanned, locations where it was last scanned, personnel involved in handling the package or reporting problems, etc. The portal may provide a subset of the information to the customer, and the full set of information to carrier personnel.

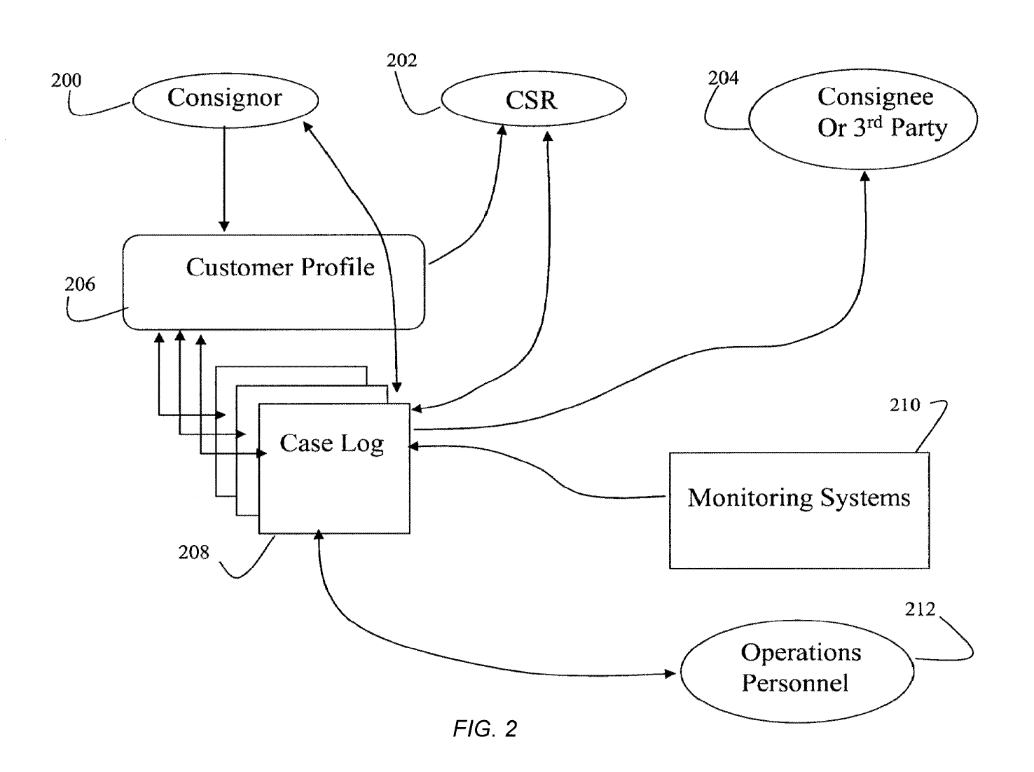

The relationship between the various entities described above is further illustrated in FIG. 2, which illustrates one embodiment of the logical relationship between the information gathered and the different parties accessing and updating the information.

In this example, the consignor 200 is the originator of the package and the entity establishing the customer profile 206. In other embodiments, the customer could be considered the consignee. The customer profile contains contact information that may be used in resolving a problem associated with a PR package delivery. The customer establishes the profile, which can contain the following information;

a. Primary Shipper Number, account holder name and address,

b. Affiliated Shipper Numbers,

c. Contact Information for PR packages,
i. Primary and secondary contacts,
ii. Name, method of contact (phone, pager, email, text messaging),
iii. When to contact (e.g., time windows, days),

d. Types of exceptions requiring customer contact,

e. Customer event preferences requiring carrier's attention
i. contingency actions to be taken when certain service affecting conditions occur, such as
   1. e.g., when/how to deliver package if package is not delivered on anticipated schedule
   2. alternate delivery location if normal delivery is impacted
   3. who to contact if an exception occurs (e.g., package is exposed to high temperature)
   4. who to contact upon delivery after an exception occur

f. Recovery Options
i. Make another delivery attempt (date and/or time specific)
ii. Upgrade package to higher level of service
iii. Line flight
iv. Return to shipper
v. Hold for Pickup at facility
vi. Hold for future instructions or future delivery
vii. Redirect to another address
viii. Refrigerate package
ix. Replenish dry ice (e.g., add more dry ice to package)
   The information listed above is not exhaustive, and is exemplary to the type of information that can be maintained. Because, as noted, the possible service impacting possibilities are varied, the information maintained should, in various embodiments, be flexible enough to accommodate different circumstances. Other embodiments may incorporate more or less information. Additional details in this regard may also be found within U.S. Pat. No. 8,489,472, the contents of which are incorporated by reference herein in their entirety.

In addition, the customer profile 206 is linked with various active case logs 208, which represent those packages associated with that customer which have been (or are currently) shipped that have been designated as receiving the PR service. In other embodiments, the case logs could actually be part of the customer profile, but in the preferred embodiment, these are separate data structures which are linked from the customer profile, as well as via other information.

In the preferred embodiment, the customer interacts with a customer service representative (“CSR”), who then interacts with the customer profile. In other embodiments, it is possible for the Consignor 200 is shown as being able to interact (e.g., read and write) information on a limited basis associated with a particular case log. The customer service profile may also be linked to closed case logs. Typically, the CSR has full authorization to modify the customer service profile, whereas a customer would have a more limited set of capabilities.

The status associated with a case log 208 can be provided by automated monitoring systems 220 or operations personnel 212. As described before, either source can provide information about a PR package. The various monitoring systems including monitoring, recording, tracking, and processing systems, which variously process packages in various locations. These include sorting, conveying, dispatching systems and equipment, and may variously involve scan and detect packages in the normal course of handling. The monitoring systems could be those systems known in the art, as well as future developed automated systems, such as those which read RFID tags on the packages, and report any abnormal conditions (including, e.g., temperature, moisture, vibration, or light). Additional technologies that may be used for monitoring further include Bluetooth, WiFi, UWB, UHF, and MMW. One of ordinary skill in the art can envision several technologies that may be utilized for various monitoring purposes.

Although not shown in FIG. 2, the operations personnel may provide information to the call log via the CSR. That is, operations personnel may call and interact with a CSR, and provide the tracking number, which in turn allows the CSR to retrieve and update information in the case log based on information provided by operations personnel.

The CSR 202 is also able to read and write information about a particular case log. Typically, the CSR is the point of contact between the carrier and the customer. Consequently, the CSR may use a computer terminal at a workstation to readily access and update information on a PR package. Finally, in some embodiments, the consignee 204 or other 3^{rd} party may be able to access information in the case log. Such permission may depend on the authorization granted by the consignor and the carrier. Typically, the system precludes a party from erasing information in a case log, as the record developed may be important in settling subsequent disputes.

In this manner, all relevant parties involved in a high-value shipment can ascertain the status, and actions taken for intervention of a package shipment, and keep abreast of up-to-date information affecting the consignor and consignee.

### Case Log Management Functions

Case log management refers to the actions that can be taken with respect to a particular case log. Typically, a case log is identified by the package tracking number and associated with a particular customer profile. In instances where a particular case log is not known, it is possible to view all pending (e.g., open) case logs associated with a customer profile and select a particular one. This is possible since the customer profile is linked with the customer's case logs. Typically, though, a package tracking number is used to identify a particular case log and is known by the party requesting case log information.

Once the case log is retrieved, there are various operations that can be performed in conjunction with a case log. The case log contents can be created, viewed or read, updated, or closed. Typically, a CSR will view or update a case log previously created. Various systems may be restricted as to the case log functions performed and how they interact with the case log. For example, in FIG. 2, the various monitoring systems may access the case log via an application programming interface (“API”) and be restricted to only updating monitoring/tracking information. Because such systems are machines, an API interface is preferable. On the other hand, the operations personnel updating the status of the case log typically use a human interface system, such as a web access or other type of graphical user interface system. Some operations personnel may be limited to updating status only, whereas others may be given greater authorization level to provide input regarding PR packages in jeopardy.

The case log maintains information about status of the package, and typically includes scan location and times along the route as the package is being processed and handled. In various embodiments, other information, such as temperature, shock, g-force, vibration, light, moisture, and noise readings, for example, may be recorded. Thus, it is within the scope of various embodiments of the present invention that various sensors affixed on or in the package may wirelessly transmit readings which are recorded at processing points along the route. Typically, once information is recorded in the log, it cannot be altered, nor can personnel delete a case log. For example, once a package is scanned at a location and time, the information cannot be amended, but only augmented. This ensures the integrity of information is maintained and that accurate records are maintained and accurate reports are produced.

FIG. 2 does not illustrate other miscellaneous inputs that can be received, which may indirectly impact case logs. A PR system may receive global or system wide information that may impact a number of packages, including some PR packages, and thus put those PR packages in a jeopardy situation. For example, a system wide information may be of a delay at a particular airport due to weather problems. The PR system (or another system) can ascertain which PR packages are affected, and update/create case logs for the appropriate packages. Once created, automatic notifications may be provided to CSRs or customers regarding the status.

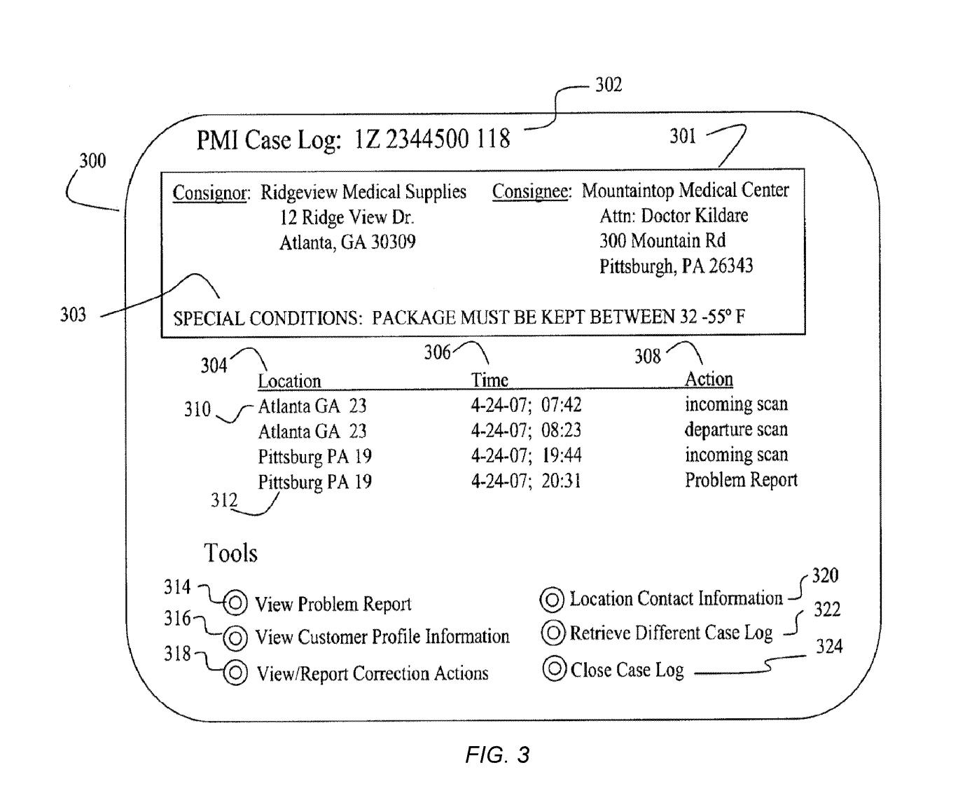

FIG. 3 illustrates one embodiment of the information presented in a call log to a CSR. FIG. 3 illustrates a screen shot 300 of some information that a CSR would view after having identified and selected a particular PR case log, as identified by the package tracking number 302. The information may include information readily available from the PLD database; including, for example, the consignor's and consignee's address 301. Other embodiments may include certain information from the customer profile (e.g., customer shipping number, contact name, etc.) The PLD information provides the CSR with some high level context regarding where the package is going from and to. The information typically also includes information specific to the critical nature of the shipment, (such as the aforementioned PR indicator code) which is typically not part of the PLD information normally retained by the carrier. In this case, this information is shown in line 303 which reflects that the contents of the package must be kept within a certain temperature range.

The next portion is the scan/location information, which indicates the location of the package scan 304, the time package scan 306, and the action that occurred 308. For example, the first entry indications the package was received in the Atlanta Ga. facility (#23) on 4-24-07 at 7:42 a.m. Typically, this table includes scan information, but it is not limited to such. For example, the last entry 312 indicates a “Problem Report” was initiated. In many embodiments, each field may be hyperlinked to other information, which provides additional details.

At this point, the CSR may select one of the tools indicated. These are exemplary, and other embodiments could present different information or options. Typically, the CSR would need to view additional information regarding the problem, which could be accomplished by selecting the “View Problem Report” icon 314. Selection would provide a text based window, presenting the user with further information regarding the problem. The problem could be identified by a code, which could be presented by itself, or which is mapped to a text message. Alternatively, the text describing the problem could be ‘free text’ that was inputted by operations personnel at the location of the problem (e.g., who first detected the problem).

The CSR could select “View Customer Profile Information” icon 316 which would provide all the relevant contact information contained in the customer profile, should the CSR need to contact the custom for any reason. As previously indicated, the customer profile maintains information for contacting the customer for certain ‘high value’ shipments, and may be a different contact than maintained for regular packages. The CSR could alternatively select “View/Report Correction Actions” icon 318 which would provide a text-based interface stating the findings of actions taken. Typically, the information presented would be augmented to report ongoing actions taken, if they occur and are reported. The CSR could select the “Location Contact Information” icon 320 which would present a window of the appropriate contact names and information (e.g., telephone number, cell phone number, etc.) for carrier operations personnel at the last location. For example, in the above example, the sorting facility at “Pittsburgh Pa. 19” may have a designated PR contact (e.g., Center Manager (Day Shift) John Smith, 412-555-1234) which the CSR could use to obtain information from the facility where the package is located. In other embodiments, the contact information would list a generic contact number of the sorting facility, without naming a dedicated contact person. Other embodiments may also, or instead, list an email or other address for the contact, or a generic email address suggestive of the function (e.g., “PR_exception_contact”). The system would link the contact information with the last known facility, which could in some instances be a dispatch driver. This facilitates the CSR being able to contact the appropriate person, at the appropriate location in a rapid and easy manner. In the case that package has been dispatched and is on a delivery vehicle, the contact information could not only include the contact information of the dispatch center, but the appropriate driver's cell phone, or other communication device information, such as an electronic address for a portable computer carried by the driver.

Finally, the CSR may be able to select “Retrieve Different Case Log” 322 for another package, or “Close Case Log” when the problem has been resolved. Other actions may be defined, to facilitate the job functions of the CSR.

The screen presented to the CSR is typically not the same information available to a customer accessing the call log over the web. Typically, additional information or functions are available to the CSR which are not made available to the customer (such as the names and contact information for operations personnel at each sorting facility). The types of information available to the customer can be controlled by carrier, and such access may be password protected or otherwise limited. The customer, which in this case is the consignor, may choose to allow other parties, such as the consignee, to access the information. In this manner, all the relevant parties can obtain real time information regarding the disposition of the package.

### Typical Application

A typical application using the various above-described embodiments is now provided to illustrate application of the same. Because a variety of problems can arise creating a jeopardy situation, and which can be reported by operations personnel or by automated systems, there are various combinations possible, which cannot all be disclosed. Therefore, it should be understood that the application discussed below is provided for illustration purposes only and in no way should be construed to limit the scope and application of the present invention. Additional illustrations and examples in this regard may also be found within U.S. Pat. No. 8,489,472, the contents of which are incorporated by reference herein in their entirety.

In one illustration a consignor ships medical supplies such as medication or an antidote, which must be kept refrigerated. The supplies are packaged using a thermally insulated container, which is surrounded therein by some form of ice packs to keep the temperature low. The supplies and ice packs are packaged up into a box, and provided to a carrier. A shipping system is used in preparing the manifest, and the necessary package level detail information (e.g., consignor, consignee, class of service, etc.) is electronically conveyed to the carrier so that the carrier knows how to process the package.

In this example, the consignor has subscribed to PR service capability, and indicates that the package is to be associated with PR service. The consignor provides a code indicating that the contents are temperature sensitive.

The package is shipped from Atlanta to Pittsburgh in the middle of summer, during a heat wave. The package is sent to the attention of a certain doctor at a hospital needing the supplies. Because of the urgency of the situation, the doctor needs to know if the supplies encounter any “problems” associated with the shipment, as is the consignor (the medical supply house) and the hospital (consignee). If the contents of the package do not remain cool, the contents will be destroyed, and the patient will suffer adverse consequences. Thus, all the parties need to know if there is a problem, and the status of the shipment.

During the course of normal handling, the various package handling and sorting equipment operated by the carrier identifies the package, and records the scan information on the package using machine readable means, as the package progresses along the route. En route, the package is received at the carrier's sorting facility in Pittsburgh near the airport. The package is readily identified as requiring proactive monitoring and intervention, typically via a label affixed to the package. Other indications may be used, such as codes in the tracking number, or other machine/human readable indications. An alert package handler notices that a corner of the packaging is wet, and dripping a clear gel-like liquid. The ice-pack in the box has developed a leak, and has soaked through the packaging. The alert package handler pulls that package out of the flow of normal sorting, and either brings it to the attention of a person designated locally as resolving such issues (the PR contact person), or the package handler personally calls a dedicated telephone number and reaches a customer service representative handling PR problems. The package handler identifies the package via the tracking number to the CSR, and the CSR retrieves the case log as associated with the tracking number. The CSR uses a computer, which connected to an intranet, accesses the PR system, which retrieves the case log from the PR database and presents it to the CSR. The CSR immediately knows that the package is destined for Pittsburgh, and that it is on time, and that the contents are to be kept cool. Specifically, based on information provided by the consignor, the contents are to be between 32-55 degrees Fahrenheit.

The CSR is able to communicate with the handler and ascertain the problem. The CSR is able to retrieve the customer profile, and contact the consignor. Specifically, the CSR is able to retrieve a telephone number and name of the consignor and identify the problem, namely that a fluid is leaking from the package. The consignor indicates that the package was packed in ice, and that some of the ice likely melted and leaked out. The consignor requests that the package be kept cool, which can occur by placing the package in a cooler with additional ice or placing the package in a special facility (e.g., refrigerator). The availability of such special facilities may vary based on location.

Alternatively, the CSR may receive information from the consignor regarding the desired action to be taken based on information stored in the customer profile, thus negating the need to call and talk to the consignor. For example, the information may indicate that the contents of the package should be repacked in ice and repackaged in an entirely new container. In addition, a temperature sensor may have been packed in the package and the information from the consignor may indicate to download the information received from the sensor to the consignor. Lastly, the information from the consignor may indicate to send a photograph of the package to the consignor for review.

In such a case, the CSR may initiate a message to the consignor indicating the problem detected and the action taken in response. The CSR relays the instructions to the handler, which the handler promptly performs and acknowledges the same to the CSR. The CSR notes the problem recorded, the actions taken, that contact with the consignor was accomplished, and that the package was iced by the carrier to avoid it from being overheated. The carrier completes delivery of the package, and the case log is manually closed in response to the delivery of the package. In the meantime, the consignor (or other party) receiving the notification may receive an email comprising the tracking number and a web-site identifying the case log, which the recipient can readily access to ascertain the status. In other embodiments, the doctor may have knowledge of the tracking number and may want to access the case log, to ascertain what happened, when, and what actions were taken.

Access to real-time information by the involved parties may mitigate any problems encountered, and provides for greater customer satisfaction. Access to the information by the consignor, the consignee, and the carrier maintained in a central repository allows the prompt identification of the problem, prompt communication of the problem, and resolution of the problem so that the medical supplies can be delivered in time.

### Apparatuses, Methods, Systems, and Computer Program Products

It should be understood that various embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a nonvolatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended information/data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use computer-readable storage medium, other types of computer-readable storage media may be substituted for or used in addition to the computer-readable storage media described above.

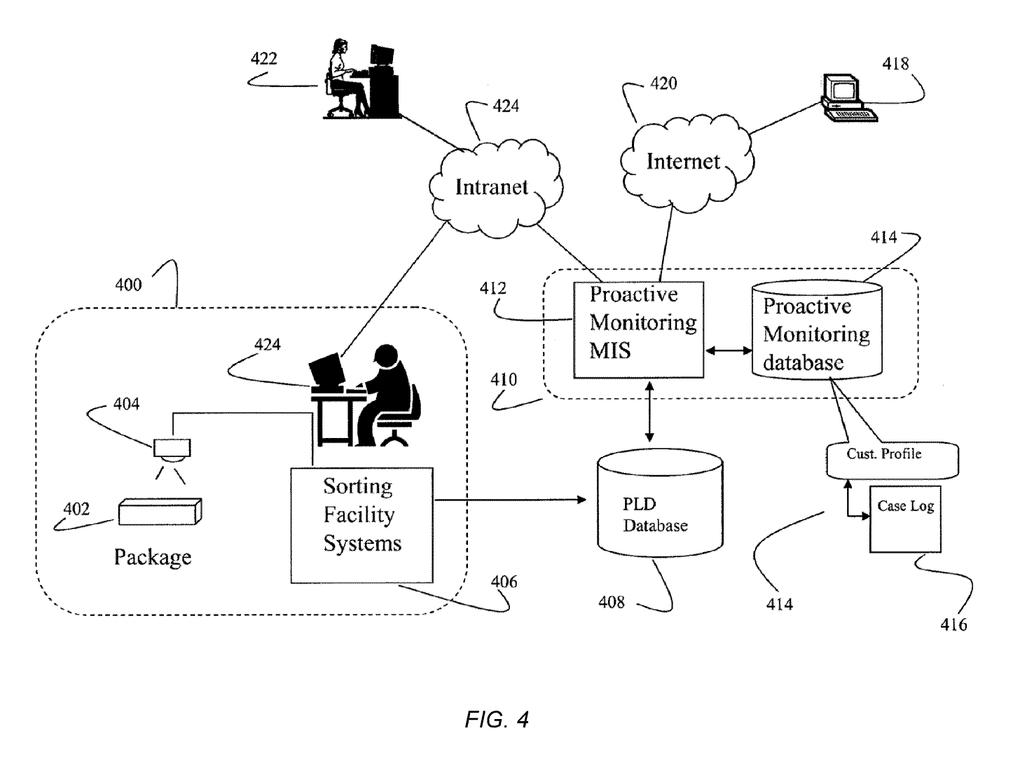

As should be appreciated, various embodiments of the present invention may also be implemented as methods, apparatuses, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations. One such exemplary system has been previously described herein in the context of at least FIG. 4.

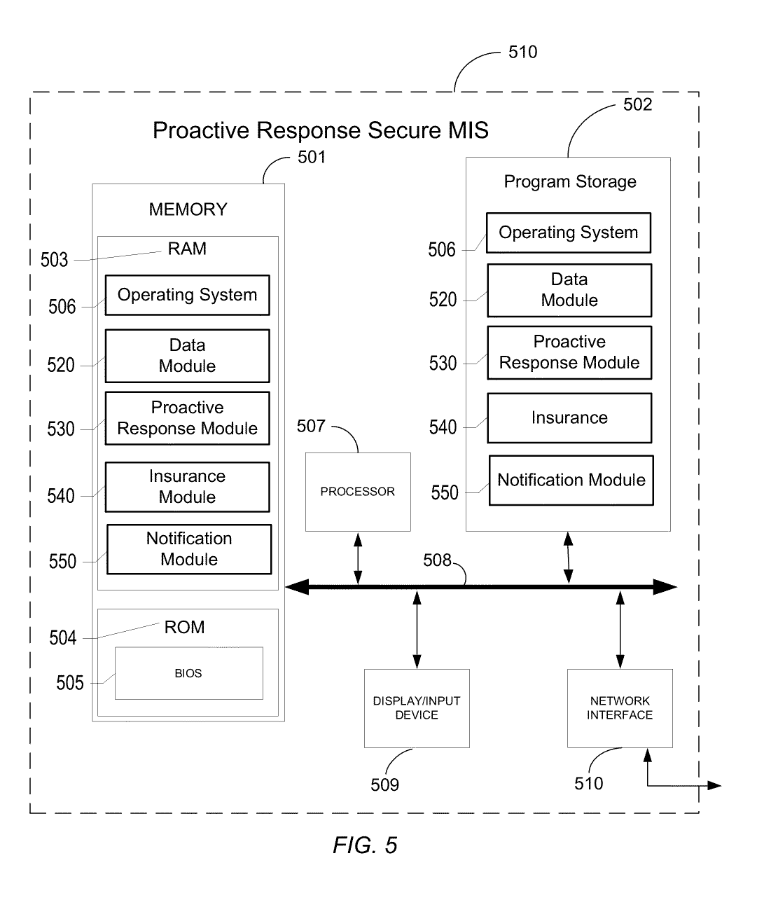

Various embodiments are further described below with reference to block diagrams and flowchart illustrations found in at least FIGS. 5-10. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

### First Exemplary System Architecture

One exemplary embodiment of the system according to various embodiments is illustrated at a high level in FIG. 4. In FIG. 4, a facility 400 is illustrated which processes packages. In the present example, a package 402 is being scanned. This refers to the process of a machine reading a package identifier which provides the package tracking number to a system 406 at the sorting facility, which is performed to determine what sorting action should be taken with respect to the present package. The sorting facility system 406 may access a PLD database 408 to determine the appropriate action. In the process, the PLD database 408 records the scan information as to where and when the particular package was last processed.

In this case, it is presumed that the package is designated as receiving PR service. This could be codified on the label, or explicitly or implicitly coded in the tracking number, so that the PLD database receives an indication that this is a PR package. Alternatively, the PLD database may treat the information as it would any other (e.g. non-PR) package and maintain a separate PR indicator stored when the PLD record was initially created.

The PLD database interacts with a PR management information system (“MIS”) 410. In one embodiment, the PLD database provides the scan information for PR packages by “pushing” PLD information to the PR database. In other embodiments, the PR MIS system 410 “pulls” information regarding specific PR packages from the PLD database. In either embodiment, the result is that the PR MIS system is able to ascertain the current scanning information for a given PR package as identified by the tracking number. Whether this information is duplicated by the PR or accessed from the PLD database is an implementation option.

The PR MIS system 410 comprises a processor 412 and a PR database 414. The PR MIS system handles queries from users and interacts with other carrier systems (such as the PLD database). The PR database 414 stores information regarding the customer profiles 414 for a specific customer and the specific case logs 416 for that customer. It should be understood that while FIG. 4 illustrates the various system entities as separate, standalone entities, the various embodiments are not limited to this particular architecture.

As noted before, a package designated as receiving PR treatment may initially have little information. In this case, a special type of a case log (e.g., one which does not indicate any exceptions) may be defined. Certainly for packages which have problems associated with them of some sort, there exists a case log file identified by the package tracking number that indicates the problem encountered.

The indication of a problem can come from various sources. For example, the PR MIS system may periodically process information pertaining to certain packages to ascertain whether the packages are on schedule, and if not, flag these packages as having a potential problem in the PR database. Other external systems (not shown) can provide indications to the PR MIS system 412 of potential or actual problems on an individual package basis or system wide basis. These will be recorded in the appropriate case log file.

A customer service representative 422 is able, via a corporate intranet 424, to access the PR system 410 and ascertain the status of a particular case log (e.g., package). This may be in response to a question for a customer (not shown) as the CSR is also able to communicate via telephone with customers as well as internal operations personnel. The PR MIS processor 412 provides the web-based interface for the CSR, and manages communications with the PR database. Further, the PR MIS processor 412 also provides access via the Internet 420 to external users, such as the consignor 418. The PR MIS system may filter information for external users, relative to the information provided to the CSR.

Finally, in order to resolve a problem, the CSR 422 is able to use the corporate intranet 424 to communicate with the appropriate personnel 424 at the appropriate facility processing the package at the moment. (Telephone access is also possible, but not shown.) The operations personnel 424 may also be able to access the case log file 416 to update information regarding the package or to address the service impacting problem (e.g., to intercept the package, take remedial action such as replenishing ice, etc.).

Some of the aforementioned components are not shown, such as the other communication infrastructure allowing the CSR to communicate with the customer (e.g., via telephone, pager, email, short message service, etc.). Further, the CSR is able to communicate with various possible personnel of the carrier, which may be in any one of several sorting facilities, or delivery vehicles (again, not shown). Further, additional databases, such as contact information for operations personnel may be integrated with the PR system 412 or be accessed via the intranet 424.

The options for communicating between the CSR and the carrier's operations personnel will be determined in part as to the stage of the delivery process the package is being handled. For example, a package requiring attention at a sorting facility may result in certain types of recovery options for dealing with an issue, and may involve certain personnel. For example, each sorting facility may have a designed “PR contact” for address issues. On the other hand, if the package is on an airplane en route, then the recovery options may be different, and require alternative means of communications. Finally, if the package is en route on the final delivery leg to the consignee, the CSR may be using wireless communication with the dispatch driver.

According to various embodiments of the present invention, the Internet 420 or Intranet 424 should be understood more generally as one or more networks that may be capable of supporting communication in accordance with any one or more of a number of second-generation (2G), 2.5G, third-generation (3G), and/or fourth-generation (4G) mobile communication protocols, or the like. More particularly, the one or more networks may be capable of supporting communication in accordance with 2G wireless communication protocols IS-136 (TDMA), GSM, and IS-95 (CDMA). Also, for example, the one or more networks may be capable of supporting communication in accordance with 2.5G wireless communication protocols GPRS, Enhanced Data GSM Environment (EDGE), or the like. In addition, for example, the one or more networks may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 5 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like

### Second Exemplary System Architecture

According to various embodiments, the system may be configured to not only provide monitoring and intervention-type related services to one or more users (e.g., customers), but to also bundle therewith a security feature, which may be tied to at least an insurance policy associated with the one or more users. In certain embodiments, the insurance and/or insurance policy is underwritten by an authorized insurance company and issued through licensed insurance producers affiliated with one or more insurance agencies; in other words, by and through one or more entities separate and distinct from the common carrier and other parties described elsewhere herein.

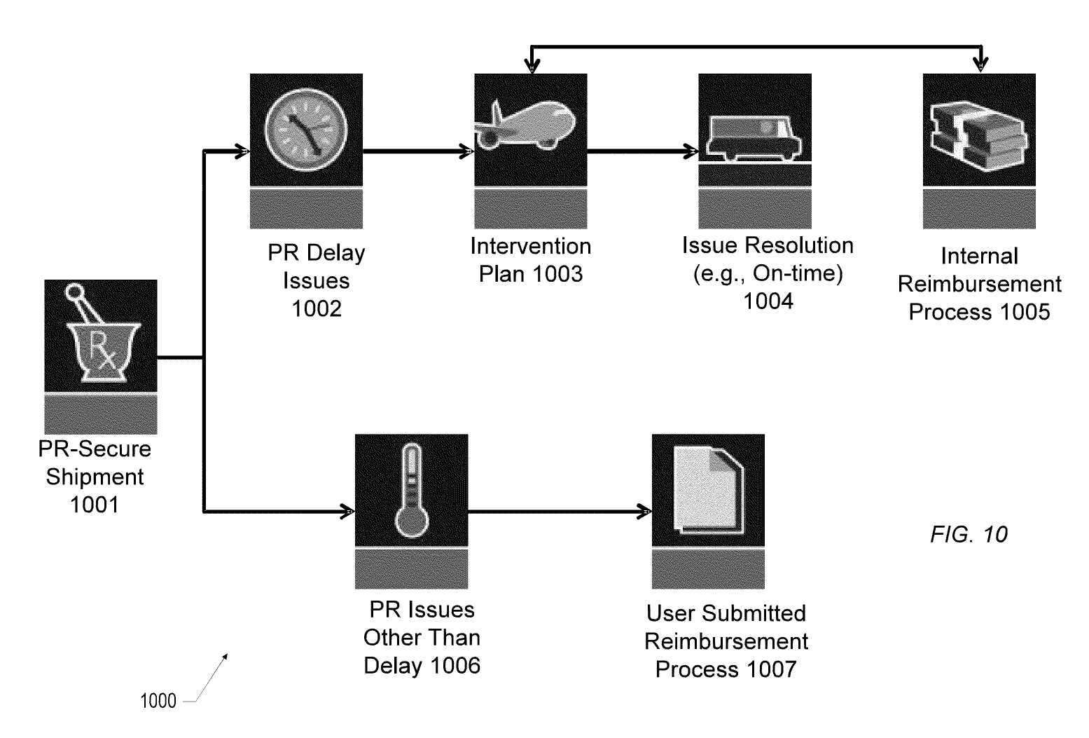

According to various embodiments, automatic insurance coverage for certain expenditures incurred (e.g., due to intervention-type related activities) may be provided. Such may be offered via a bundled flat-rate package or otherwise, as may be desirable for particular applications and as will be described in further detail elsewhere herein. In other embodiments, expediting expenses (e.g., those associated with intervention activities resulting from delays in transit would be automatically covered and/or internally processed without the need to inconvenience customers with a formal claims submittal process. Loss or damage expenses incurred, including those resulting from observed conditions that impacted the perishability of the item/package/parcel, would also be covered according to various embodiments, but generally require a formal claims submittal process to provide reimbursement. Such alternative flows may be seen in at least FIG. 10, which will be described in further detail elsewhere herein. Indeed, all of these and other features of the second exemplary system architecture will be described in much further detail below with reference to at least FIGS. 5-10. It should be understood, however, that the primary distinction between the first exemplary system architecture and the second exemplary system architecture lies in the security features (e.g., insurance coverage) for which the latter is configured to provide in a substantially seamless and efficient manner.

FIG. 5 is an illustration of another exemplary embodiment of the system according to various embodiments, which is configured as described above to provide additional security features (e.g., insurance coverage). In FIG. 5, a schematic diagram of a proactive response secure (“PRS”) management information system (“MIS”) 510 is illustrated. Generally speaking, it should be understood that the configuration of the PRS MIS 510 is, in certain embodiments, substantially the same as that described previously herein with respect to the PR MIS 410, which is illustrated in FIG. 4, except for distinguishing features, as will be described in further detail below. In other embodiments, however, it should be understood that any of a variety of features may differ between the PRS MIS 510 and the PR MIS 410, provided both nevertheless are configured to provide the proactive monitoring and intervention/resolution capabilities described elsewhere herein. Amongst other possible various differences, it should also be understood that the PRS MIS 510 provides an integrated insurance coverage feature, which may be configured according to various embodiments to provide a combination of automatic and reimbursable coverage for costs, fees, and the like incurred due to implementation of one or more intervention activities, all as will be described elsewhere here.

Turning specifically now to FIG. 5, the PRS MIS 510 includes a processor 507 that communicates with other elements within the system via a system interface or bus 508. In certain embodiments, the processor 507 may be substantially the same, at least structurally, as processor 412 described with regard to FIG. 4. While the foregoing describes a single processor 507 (or 412), as one of ordinary skill in the art will recognize, the PRS MIS 510 may comprise multiple processors operating in conjunction with one another to perform the functionality described herein. In addition to the memory 501, the processor 507 can also be connected to at least one network interface 510 or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface/device 509, in turn, can comprise any of a number of devices allowing the entity to receive data from a user, such as a keypad, a touch display, a joystick or other input device.

Remaining with FIG. 5, also included in the PRS MIS 510 is a display/input device 509 for receiving and displaying data. This display/input device 509 may be, for example, a keyboard or pointing device that is used in combination with a monitor. The PRS MIS 510 further includes memory 501, which preferably includes both read only memory (ROM) 504 and random access memory (RAM) 503. The server's ROM 504 is used to store a basic input/output system 505 (BIOS), containing the basic routines that help to transfer information between elements within the PRS MIS 510. Various ROM and RAM configurations have been previously described herein.

In addition, the PRS MIS 510 includes at least one storage device or program storage 502, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 502 are connected to the system bus 508 by an appropriate interface. The storage devices 502 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 502 and/or memory of the PRS MIS 510 may further provide the functions of a data storage device, which may store historical and/or current delivery data and delivery conditions that may be accessed by the PRS MIS. In this regard, the storage device 502 may comprise one or more databases. Such databases may be substantially analogous to the proactive monitoring database 414 and the PLD database 408, as previously described herein. Of course, still further databases may be included within the storage device 502 as will be described in further detail below. Still further, it should be understood that the term “database” refers to a structured collection of records or data that is stored in a computer system, such as via a relational database, hierarchical database, or network database and as such, should not be construed in a limiting fashion.

As previously mentioned, also located within the PRS MIS 510 is a network interface 510 for interfacing and communicating with other elements of the one or more networks (e.g., the Internet and/or the Intranet, as illustrated in FIG. 4). It will be appreciated by one of ordinary skill in the art that one or more of the PRS MIS 510 components may be located geographically remotely from other components. Furthermore, one or more of the PRS MIS 510 components may be combined, and/or additional components performing functions described herein may also be included in the server.

A number of program modules comprising, for example, one or more computer-readable program code portions executable by the processor 507 (which, again, may be substantially similar to the proactive monitoring MIS processor 412 described previously herein) may be stored by the various storage devices 502 and within RAM 503. Such program modules include an operating system 506, a data module 520, a proactive response module 530, an insurance module 540, and a notification module 550. In these and other embodiments, the various modules 520, 530, 540, 550 control certain aspects of the operation of the PRS MIS 510 with the assistance of the processor 507 and operating system 506. In still other embodiments, it should be understood that one or more additional and/or alternative modules may also be provided, without departing from the scope and nature of the present invention.

In various embodiments, the program modules 520, 530, 540, 550 are executed by the PRS MIS 510 and are configured to generate one or more graphical user interfaces, reports, instructions, and/or notifications/alerts, all accessible and/or transmittable to various users of the system. In certain embodiments, the user interfaces, reports, instructions, and/or notifications/alerts may be accessible via one or more networks (e.g., the Internet 420 and/or Intranet 424 of FIG. 4 or as otherwise described herein) or other feasible communications infrastructures, as commonly known and understood. In other embodiments, one or more of the modules 520, 530, 540, 550 may be alternatively and/or additionally (e.g., in duplicate) stored locally on one or more of the devices 418, 422, 424 (see FIG. 4 again), and may be executed by one or more processors of the same. According to various embodiments, the modules 520, 530, 540, 550 may send data to, receive data from, and utilize data contained in, one or more databases, which may be comprised of one or more separate, linked and/or networked databases, all as will be described in further detail below.

According to various embodiments, many individual steps of a process may or may not be carried out utilizing the computer systems and/or servers described herein, and the degree of computer implementation may vary.

A. Data Module 520

In general, the data module 520 is configured to receive, store, manage, and transmit a variety of package level detail (PLD) data 408A, flex parcel insurance data 413A, and proactive monitoring data 414A, which together may comprise any of a variety of data associated with the tracking and monitoring of activities and conditions during transit of one or more packages or parcels, data associated with one or more intervention activities configured to mitigate one or more observed conditions deviating from an expected and/or desired condition, and data associated with one or more insurance coverage plans that directs billing and payment for any costs incurred as a result of at least the intervention activities noted above. At least certain of this data (e.g., proactive monitoring data and PLD data have been described, to certain degree, previously herein, with respect to PR MIS 410 (see FIG. 4).

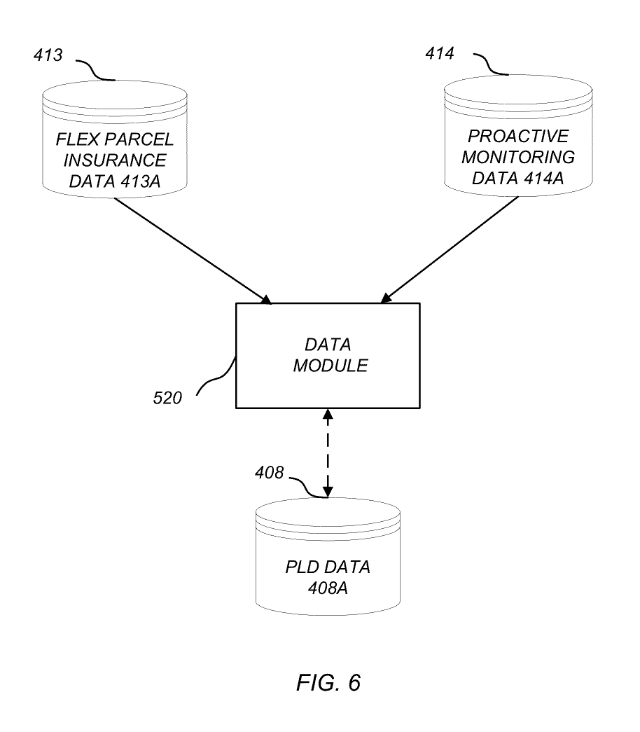

With reference to FIG. 6, it should be understood that the data module 520 may be associated with one or more databases, much like the association between PR MIS 410 and the PLD database 408 and the proactive monitoring database 414 described previously herein. Indeed, as illustrated in FIG. 6, according to various embodiments, the data module 520 may be configured to communicate with the actual proactive monitoring database 414 and the PLD database 408, both as previously described herein. As such, the data contained therein may be, according to certain embodiments, substantially the same as previously described herein. Of course, in other embodiments, still further variety of package level detail (PLD) data 408A and/or proactive monitoring data 414A may be provided or exchanged, as should be commonly known and understood in the art.

Remaining with FIG. 6, it may be seen that the data module 520 may be further associated according to various embodiments with a flex parcel insurance database 413, which may contain a variety of flex parcel insurance data 413A. Such flex parcel insurance data 413A may comprise data such as the non-limiting examples of policy coverage details, policy rate structure options, policy bundling options with the base “proactive response” service described elsewhere herein, policy procedures, and the like. Still further, the flex parcel insurance data 413A may comprise data regarding availability of one or more sub-sets of policy types, which may be dependent at least in part upon other data, such as the PLD data 408A, such that certain coverage may only be available for packages of a certain value, size, or the like, as may be desirable according to various applications.

It should be further understood that the flex parcel insurance data 413A may further include a variety of billing structure data, both for the insurance policies and services offered thereby and for the combined (e.g., bundled) offering thereof in conjunction with the “proactive response” services described elsewhere herein. Billing, rate, and claim processing details may likewise be defined within the flex parcel insurance data 413A, although in certain embodiments, at least some portion of the data may be maintained within a customer profile 414 and/or case log 416, as described elsewhere herein.

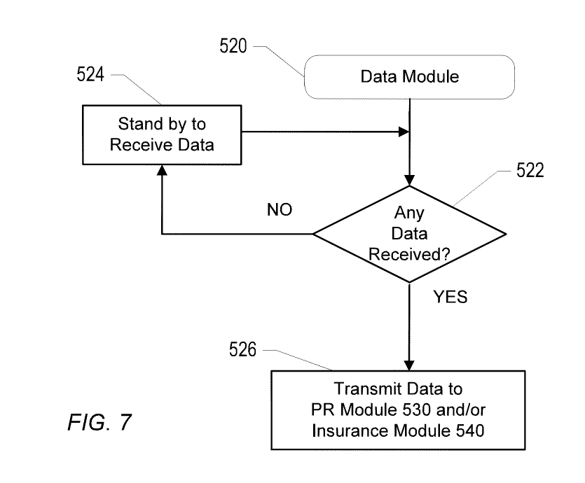

Turning now to FIG. 7, according to various embodiments, as previously mentioned herein, the data module 520 is configured to receive, store, manage, and transmit a variety of data (see FIG. 6). Receipt may be from any of a variety of entities (e.g., a common carrier shipment provider, users of the system, and the like, as previously described elsewhere herein) depending upon the type and nature of the data (see also FIG. 4), and transmission thereof may be to one or more of the PR and/or insurance modules 530, 540, as will be described in further detail below.

FIG. 7 illustrates steps that may be executed by the data module 520 according to various embodiments. Beginning with step 522, the data module 520 assesses whether any data has been received by the module. In certain embodiments, the data module 520 makes this assessment by periodically scanning one or more databases (see FIG. 6) associated with the module and by identifying some portion of data within one or more of the databases that was not present during a previous periodic scan under step 522. Of course, alternative configurations may be envisioned, wherein, as a non-limiting example, data module 520 may actively receive data (e.g., as input by a user of the system via an interface or otherwise) and upon receipt thereof, execute step 522. In any of these and still other various embodiments, if “newly received” data is identified, the data module 520 proceeds to step 526; otherwise the module proceeds into a static loop via step 524.

During step 524, the data module 520 may be configured to passively stand by for receipt of new data. In certain embodiments, the data module 520 may, in step 524, periodically (e.g., every 5 seconds, or at any desirable interval) proactively ping one or more databases contained therein. Of course, various alternative data monitoring configurations may be envisioned, without departing the scope and nature of the present invention.

Remaining with FIG. 7, upon receipt of at least some portion of data (whether of a condition (e.g., via one or more users and the proactive monitoring database 414) or insurance claim or processing data (e.g., via one or more users and the insurance database 413) or otherwise), the data module 520 proceeds to step 524, during which the data module transmits the received data to at least one of the proactive response (“PR”) module 530 and/or the insurance module 540 for further handling and processing. In certain embodiments, it should be understood that the module to which data is transmitted depends at least in part upon the type of data received and context in which such receipt occurs.

In any of these and still other embodiments, the data module 520 may be configured to automatically perform step 524, while in other embodiments, the module may perform such only periodically, at an interval predetermined by one or more users of the system, as may be desirable for particular applications. In still other embodiments, the data module 520 may automatically transmit a portion of the data (e.g., proactive monitoring data 414A), while another portion of the data (e.g., insurance data 413A) may be transmitted subsequently and/or at least in part manually, depending, for example, upon or more user or otherwise-defined parameters. Of course, still further alternative configurations and/or process flows for execution by the data module 520 may be envisioned, without departing from the nature and scope of the various embodiments of the present invention.

B. PR Module

With reference now to FIG. 1, it should be understood that the PR Module 530 is configured according to various embodiments to execute at least steps 100-112, as have been described elsewhere herein. In certain embodiments, at least steps 100 and 102 may be executed by another module (e.g., the data module 520) or otherwise, as may be desirable for particular applications. However, it should be generally understood that the PR module 530 is invoked according to various embodiments upon an indication or otherwise received request (e.g., from a user, customer, or the like) to have the contents of a package for which shipment is requested subjected to the “proactive response” service, as described elsewhere herein.

With continued reference to FIG. 1, it should be understood that the PR module 530 may be configured according to various embodiments to open a “case log” (see also FIG. 4, item 416), whereby observed condition data may be observed. In certain embodiments, as described elsewhere herein, the case log may only be created (e.g., via step 104 of FIG. 1) upon occurrence of an “at risk” incident (e.g., an event potentially requiring intervention activities be commenced). The PR module 530 may be further configured to proactively and/or continuously monitor progress of the package or item being transported, resolve any issues (e.g., “at risk” incidents) that may arise, and in certain embodiments close the case log (e.g., via step 108) upon resolution of the issue. Of course, any of a variety of alternative configurations of the PR module 530 may be envisioned, although it should be generally understood that such should nevertheless be configured to provide at least all of the features and services described previously herein with respect to the PR service of FIGS. 1-4.

C. Insurance Module

The insurance module 540 is configured according to various embodiments to manage and process the “secure” features associated with the system, so as to ensure any costs incurred due at least in part to intervention activities (e.g., to replenish ice on a package, to implement express critical “next flight out” reroutes of packages, or otherwise) are appropriately charged to a customer/user of the system, reimbursed thereto in accordance with one or more submitted claims, and/or automatically covered by an entity other than the consignee or consignor (e.g., a transit carrier provider or a provider of the system described herein, however as may be desirable according to various applications).

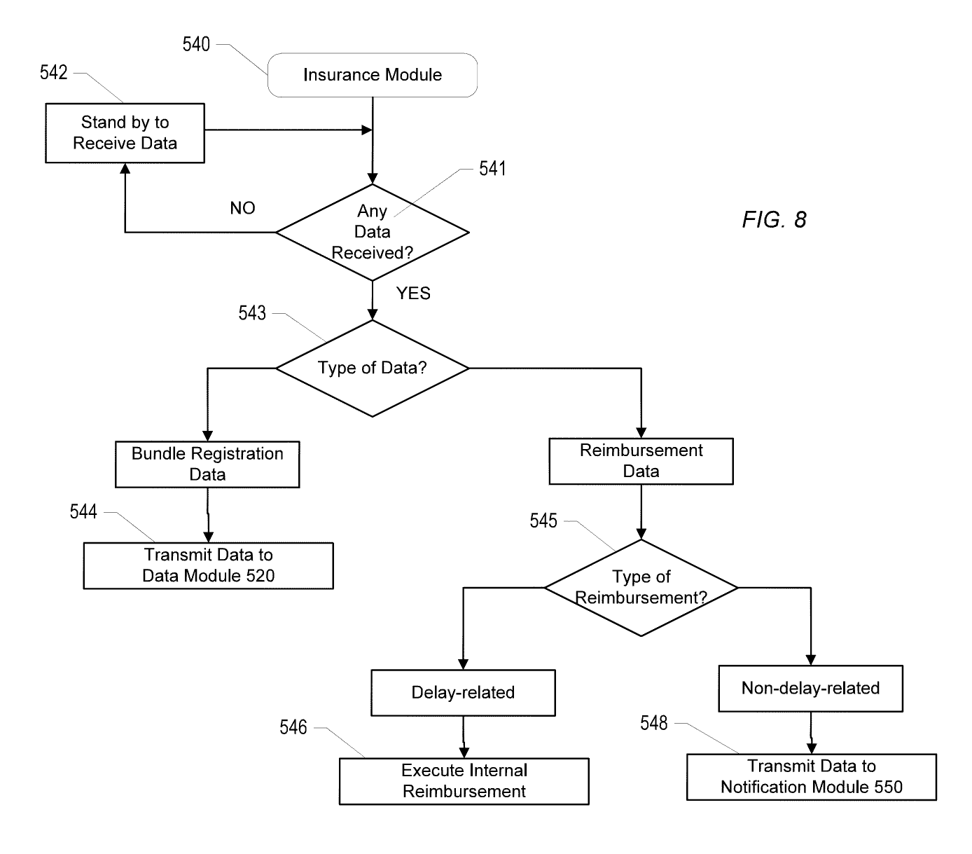

FIG. 8 illustrates steps that may be executed by the insurance module 540 according to various embodiments. Beginning with step 541, the insurance module 540 assesses whether any data has been received by the module. In certain embodiments, the insurance module 540 makes this assessment by periodically scanning one or more databases (see FIG. 6) associated with the module and by identifying some portion of data within one or more of the databases that was not present during a previous periodic scan under step 541. Of course, alternative configurations may be envisioned, wherein, as a non-limiting example, insurance module 540 may actively receive some portion of flex parcel insurance data 413A (e.g., as input by a user of the system via an interface, directly from the data module 520 and/or the PR module 530, or otherwise) and upon receipt thereof, execute step 541. In any of these and still other various embodiments, if “newly received” data is identified, the insurance module 540 proceeds to step 543; otherwise the module proceeds into a static loop via step 542.

During step 542, the insurance module 540 may be configured to passively stand by for receipt of new data. In certain embodiments, the insurance module 540 may, in step 542, periodically (e.g., every 5 seconds, or at any desirable interval) proactively ping one or more databases contained therein. Of course, various alternative data monitoring configurations may be envisioned, without departing the scope and nature of the present invention.

Remaining with FIG. 7, upon receipt of at least some portion of flex parcel insurance data 413A (whether of registration data indicative of application of one or more proactive response services and one or more insurance policy services—referred to collectively hereinafter as Proactive Response Secure (“PRS”) service bundle, or otherwise), the insurance module 540 proceeds to step 543, during which the module further assesses the particular type of data received. If the received data comprises registration-related data, the insurance module 540 may be configured according to various embodiments to proceed to step 544, where such data is simply transmitted to at least the data module 520 for updating of one or more records contained therein, for example within a customer profile 414 (as illustrated in FIG. 4).

If instead of registration data, some sort of reimbursement, billing, or otherwise incurred expense data is received, the insurance module 540 is configured according to various embodiments to proceed to step 545, wherein the specific type of data is further distilled. For example, the data may comprise data related to expenses incurred during intervention activities and thus now some sort of reimbursement thereof to one or more users of the system is necessary. In certain embodiments, under what may be applied as automatic insurance coverage along with a proactive monitoring service, expedited (e.g., express critical) expenses incurred due to delay or error created by someone other than the customer, consignee, and/or consignor of the package may be included within the provided coverage of the policy, such that no reimbursement is necessary. In such embodiments and still others, the insurance module 540 may be configured to proceed to step 546, wherein an internal reimbursement is provided between either the common carrier provider or the provider of the system and the service provider via which the expedited (e.g., express critical) expenses were incurred. Such has, amongst other advantages, the benefit of eliminating the claims/reimbursement process for the true customer/client who is receiving and/or shipping the package, thus making the intervention service must more attractive and manageable.

As a non-limiting example, where a package en route on the ground to Denver from St. Louis is delayed during transit by a transit truck (e.g., semi-truck & trailer configuration or the like) breakdown, the packages being monitored with the “proactive response” service described previously herein may be flagged for rerouting to the closest airport, with instructions to place them on the next flight out from Kansas City to Denver. When such occurs various external parties (e.g., parties other than the common carrier service provider) may provide one or more services during at least some portion of the process. For example, a third party trucking company may rush the packages to the airport on their vehicle. A third party air carrier may also be used when, for example, such provides the “first flight out” as compared to a later flight that may or may not even be offered by the common carrier service provider. Such third parties impose charges for such services, and such may be relatively significant, depending on the degree of rush and/or urgency involved with various scenarios.

Without the insurance module 540 and the policy service associated therewith, in the past consignees and consignors have not been “secure” with respect to such expenses, oftentimes being hit with passed through charges of thousands of dollars for intervention-based costs accrued via a “proactive response” service received from the common carrier service provider. Via the insurance module 540 and the PRS MIS 510 system described herein, the accrued third party costs, due to delay, would be settled between the common carrier provider and the third party, without involvement of the consignee and/or the consignor. In certain embodiments, such would involve at least some degree of automatic accounting and wire transfers, as are commonly known in the art. Under these and still other embodiments, the common carrier provider would be “reimbursed” such expenses via a bundled “flat-rate” charge imposed on the consignee and/or the consignor for registration with the PRS MIS 510 system. This streamlined billing would also eliminate the hassle and headache of submitting formal claims against an insurance policy according to various embodiments, where the internal exchange between common carrier and third party would be virtually seamless and separate from at least the consignor.

The above non-limiting example may also be understood with reference to FIG. 10, which illustrates an exemplary flow diagram 1000 of the transit, monitoring, intervention, and claim/reimbursement process. In step 1001, shipment commences on a package that has been identified as a PR package, as previously described herein. In step 1002 delay-related issues (e.g., like those described above, or otherwise) are encountered, with an intervention plan being generated and implemented in step 1003 (e.g., taking “next flight out”). Upon arrival at a destination location, step 1004 may provide further resolution, for example with a separate third party delivery company (or perhaps the common carrier provider) getting the package to the location on time. In step 1005 any third-party accrued costs are reimbursed/settled between the third party and the common carrier provider and/or the insurance provider of the insurance policy described elsewhere herein, without involvement of the consignor (and/or consignee), for payment of costs, submittal of a claim, or otherwise.

Returning now to FIG. 8, it should be understood that according to various embodiments of the PRS MIS 510 system, non-delay related intervention activities may be handled differently than those initiated and resolved due at least in part (or primarily, or substantially, or entirely) due to delay-related factors. In particular, via step 548, the insurance module 540 may be configured to transmit data associated with non-delay related activities, including costs associated therewith to at least the notification module 550. In certain embodiments, the data may also be transmitted to the data module 520; however, it should be understood that via the notification module 550, as will be described in further detail below, one or more alerts, messages, reports, or instructions may be generated and transmitted to one or more users of the system, thus at least facilitating the initiation of a conventional “formal claims processing” flow so as to reimburse the third party service providers for costs accrued during the course of providing intervention services (e.g., an entity replenishing ice on a package containing a perishable item, or the like). In contrast with the delay-related interventions, as previously described herein, where a settling of costs and accounts occurs solely between the third party service provider and the common carrier provider (whether at least in part automatically, at least in part manually, or otherwise), in the context of non-delay related intervention expenses, such must be processed such that the settling occurs between the insurance provider and the third party service provider, as would be otherwise conventional in the field of insurance policy provisions.

The processing and handling of non-delay related insurance data 413A by the insurance module 540 according to various embodiments may be further understood with reference back to the non-limiting example of transit between St. Louis and Denver, but with occurrence this time of a refrigerant breakdown on a truck transporting the package. As an intervention activity, a third party ice replenishment service provider may be enlisted to intercept the transporting truck and ice (and/or re-ice) the package or packages needing continued temperature controlled conditions. Expenses accrued via such activities would be processed by the insurance module 540, ultimately with notification to at least one of the consignor and/or consignee (which may be dependent upon terms of an external contract entered into there-between). The consignor, or otherwise holder of the insurance policy and coverage provided via the PRS MIS 510 system would then initiate a formal claims process, seeking coverage and thus reimbursement of the accrued “ice replenishment” expenses from the insurance provider.

With reference again to FIG. 10, the process flow for handling of non-delay related insurance data 413A is illustrated via steps 1006 and 1007, whereby when proactive response (“PR”) issues other than delay (e.g., temperature variations for a perishable item in a package, or the like) are encountered, mitigated, and resolved, a user of the system via step 1007 submits a formal claim on the insurance policy provided via the system. In comparison to the handling of the delay-related expenses, it should be understood that in certain embodiments, it is envisioned that carrier introduced (e.g., delay) costs will be borne by the common carrier provider, although such may be at least in part or in whole recouped via the flat-rate bundled costs charged by the common carrier provider for the PRS bundled service for monitoring, intervention, and insurance features. Non-delay costs (e.g., replenishment of ice, and the like) may not in all instances be common carrier introduced, and thus the traditional claims process may be incorporated according to various embodiments, involving further the consignee. Of course, any of a variety of alternative embodiments, both with bundling of services, rates therefor, and processing of claims and expenses arising therefrom may be envisioned, without departing from the scope and nature of the present invention. Indeed, in still other embodiments, the delay-related reimbursement process may not even be substantially automatically, but instead require one or more manual approvals, whether introduced via the notification module 550 (as described below) or otherwise.

D. Notification Module

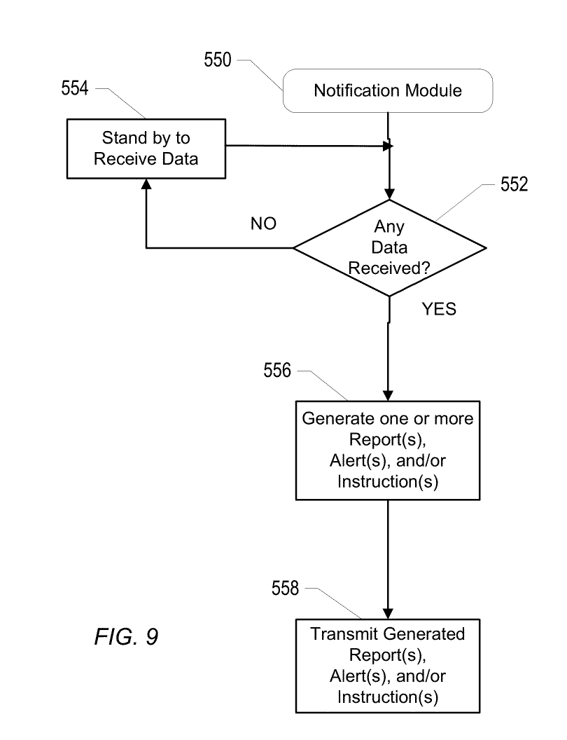

With reference to FIG. 9, according to various embodiments, the notification module 550 is configured to generally receive various types of data from at least one of the PR module 530 and/or the insurance module 540, and to subsequently perform further processing steps based thereon. Beginning with step 552, the notification module 550 may be configured to query whether any items of data have been received by the module. If no data has been received, the notification module 550 is configured according to various embodiments to proceed to step 554, wherein the module stands by to receive one or more pieces of data. In certain embodiments, the notification module 550 may simply passively await receipt of data during step 554, while in other embodiments, the module may at least periodically (e.g., as pre-determined by one or more users of the system) actively query one or more of the modules 520, 530, and/or 540 for data, as may be desirable for particular applications. Of course, any of a variety of data calling and/or transmission configurations may be envisioned, without departing from the scope and nature of the present invention.

Remaining with FIG. 9, upon receipt of data in step 552, various embodiments of the notification module 550 are configured to proceed to step 556, during which one or more notifications are generated for subsequent transmittal (e.g., during step 558) to one or more users of the system. It should be understood that according to various embodiments, the recipient(s) of the notifications may depend at least in part upon the nature and content of the data received, as has been described previously herein (e.g., differing processing if delay or non-delay related insurance data, or the like).

Specifically during step 556 of FIG. 9, the notification module 550 is configured according to various embodiments to generate one or more reports and/or alerts and/or instructions based at least in part upon the received data. The determination of whether reports and/or alerts and/or instructions are necessary may be informed, at least in part based upon one or more notification parameters, as may be pre-established by one or more users (e.g., shippers, carriers, customers, etc.) of the system, however as may be desirable according to various embodiments. Non-limiting examples of reports may comprise an email message, a document detailing status and/or actions taken by the system, and/or any of a variety of textual and/or graphical depictions thereof, as are commonly known and understood in the art.

In certain embodiments, the reports generated via step 556 may, for example, include at least some portion of the case log 416, as illustrated in at least FIG. 4. Indeed, the closed case logs can serve as data for generating reports for a particular customer, typically the consignor. The closed case logs can be used to ascertain how many PR packages were sent in a time period, what percentage of them required intervention, the outcomes, what costs were accrued as a result thereof, what types of costs were accrued, the coverage and processing thereof (whether automatically, internally, or otherwise via, for example, a conventional claims submittal process), and so forth. The report data can be used to ascertain particular problem in certain routes, or with certain types of recurring problems. The PR MIS system 410 and/or the PRS MIS system 510 may generate such reports, and present them to the user in graphical form. It is possible that the closed case logs can be archived and stored in a different database system, so as to keep the storage requirements low for the primary PR database, as described elsewhere herein.

Non-limiting examples of alerts 714 may be more simplistic notifications than, for example, reports, instead merely requiring a recipient thereof to access a separate application to obtain detailed information, as is also commonly known and understood in the art. One example of an alert may be a text message. Non-limiting examples of instructions may be textual and/or computer program-based code configured to facilitate implementation of one or more actions necessary to undertake the intervention, resolution, and/or insurance coverage steps associated with execution of the PR MIS system 410 and/or the PR MIS system 510 both as described elsewhere herein. For example, the instructions may instruct automatic processing of settlement between a common carrier provider and a third party intervention service provider with regard to expenses accrued related to delay-causing factors.

In any case, as alluded to above, upon generation of one or more and/or alerts and/or instructions during step 558 the notification module 550 according to various embodiments is configured to proceed to step 558, wherein the one or more reports and/or alerts and/or instructions are transmitted to one or more users (e.g., shippers, carriers, providers, insurers, customers, etc.) of the system. In certain embodiments, the generated reports and/or alerts and/or instructions may be further transmitted to at least the data module 520, wherein such may be stored, maintained, and/or cataloged within the PLD data and/or insurance data and/or proactive monitoring data (see FIG. 6), or even other various categories of data, all for future reference, where such may be beneficial for certain applications.

### General Billing Considerations

As previously described herein, the billing for the PR and the PRS services may occur in several ways, including a flat rate for every package indicated as such, with the surcharge added to the customer's account on a billing cycle basis. Alternatively, the billing may be incremental, based on the actions incurred for a particular package, with surcharges for performing additional icing, or upgrading of service. In yet another embodiment, a combination of various forms of charges may be levied, including an accessorial charge, with the increment in line flight costs or other billable actions specifically charged to an indicated account.

In those embodiments under PRS services, the system may be configured such that insurance coverage is automatically bundled with all PR-identified services. In other embodiments, the insurance coverage may be optional, as may be desirable for particular scenarios. In these and still other embodiments, surcharges for performing additional icing, or upgrading of service due to delay may be processed via the insurance policy coverage, as opposed to be levied in a bill and/or invoice to a user of the system. In certain embodiments, as described previously herein, charges incurred due to delay-caused intervention services may be automatically covered and settled without involvement of the customer, thus providing a streamlined billing process, which may, for example, be provided on a monthly basis. In such embodiments, the expediting (e.g., due to delay) charges may be recouped, at least in part (or in other embodiments in whole or substantially in whole) by the common carrier provider via an appropriately tailored flat-rate fee, charged over a period of time to the customer. In these and other embodiments, it should be understood that at least some portion of surcharges (e.g., those that are, in some embodiments, non-delay caused—such as re-icing) may be billed and/or invoiced to the customer. In such instances, for those embodiments having the “secure” insurance feature, reimbursement for such charges may be processed via a conventional insurance claiming process. Of course, any of a variety of alternative configurations and/or combinations of elements and features may be envisioned, without departing from the scope and nature of the present invention.

### Automatic Notifications

Although described above in the context of the notification module 550 of the PRS MIS system 510, it should be understood that notifications may be provided likewise via the PR MIS system 410, as described elsewhere herein. In either scenario, the customer (consignor, consignee, or third party, if authorized) may desire to receive automatic notifications, such as via telephone calls or emails (or otherwise), reporting the existence of problems and their resolutions, including with the ultimately delivery of the product at the end destination. The customer's preference and contact information would be contained in the customer profile, and the PR system would process each case log file to determine the appropriate action in the given circumstances. It is possible that automatic notifications could comprise normal delivery events, abnormal events or conditions, or a combination. Notifications could also relate to insurance coverage available/existing with regard to one or more proposed intervention-related activities being offered to the customer. Confirmation could be provided to the various or multiple parties. Severity codes can be defined to describe the abnormal events in the case log, and reporting actions can be made dependent on the severity codes. It is also possible for the carrier to define whether the CSR is notified first (and then notifies the customer) or whether both the CSR and customer are simultaneously notified.

### Inputs Regarding System Level Impacts

The PR MIS processor 412 of FIG. 4 (and analogously the PRS MIS processor 507 of FIG. 5) can receive other inputs (not shown), which are not related to a particular package, but which provides information of system level impacts. These include notifications of weather delays at one or more airports, equipment malfunctions or other delays (e.g., traffic congestion) impacting a particular airplane or delivery vehicle, or indicating other events or conditions at a sorting facility. In short, this information could comprise any information impacting delivery of a plurality of packages (both PR and non-PR). It can be readily appreciated that the information can be varied, and it is not possible to describe all possibilities herein. Typically, such information will be provided in a manner allowing a group of packages to be identified. For example, many packages are grouped into a larger container, which is tracked as a separate type of container, and a database maintains the relationship between the large container and the packages contained therein. For example, the large containers loaded as cargo into airplanes are sometimes referred to as “igloos” based on their shape. Thus, if the large container, such as an igloo, is associated with an aircraft and delays are currently being experienced at an airport, identification of the igloo allows identification of all the relevant packages conveyed therein. Typically, databases are maintained with the mapping, and a number of ‘nested’ container may be involved.

In this manner, system level impacts can be determined with respect to the appropriate packages in the PLD database. In one embodiment, a flag is recorded in the PLD database indicating that the package may be delayed. A separate application program could periodically poll the PLD database to ascertain and identify which of these are PR packages that may be impacted. Whether the information is maintained in one database or several, and whether they are implemented in a single computing system, a distributed system, or some other architecture is an implementation dependent aspect.

Such system level impacts can be provided to the PR system, which then identifies those PR packages currently, or scheduled, to be conveyed the airplane or vehicle, or otherwise processed at the impacted facilities or locations. This allows the PR system to proactively indicate a potential service impacting scenario, and notify the consignor, consignee, CSR, or other party of the potential problem. The notification message can be via email, and can include the package tracking number, and an address for the recipient to contact the carrier, including, for example, a web-site address (e.g., URL) and/or a telephone number or email address of a CSR focusing on aiding customers with PR related problems. Further, the PR system (or the CSR after being notified) may generate or request appropriate recovery actions for each of the PR packages. For example, time-sensitive packages which are anticipated to be delayed because of weather conditions at an airport may be rerouted via another airport. Packages which may require additional temperature stabilization to remain cool may result in exception handling processing indications when sorted at a facility. Such packages, when scanned, are shunted aside for exception handling, and local package handling personnel are notified that refrigeration and/or re-icing should occur, and the package should be routed as normal thereafter. Other packages may undergo a service level upgrade, e.g., from 2^{nd} day air to next day air. Still, other packages may be required to be sent back to the shipper.

Severity codes can be defined and associated with a package describing the impact of system impacts (as well as package-specific circumstances). The use of severity codes can be used to prioritize investigations, or prioritize potential actions taken by the carrier to resolve the problem.

In some embodiments, the actions taken by the carrier will first be checked with the customer profile to see if the actions are compatible with the recovery actions allowable for the package as indicated by that customer. If the action is not identified as allowable, the CSR may be notified that customer contact is required, and manual intervention may be required. Generally, it is preferable that automatic intervention, wherever possible, occurs. Hence it is desirable that the customer profile contain as much information as possible as to how anticipated problems should be resolved. Even in the case of automatic intervention, the PR system notes the potential problem and intervention performed in the case log for the package. It is implementation dependent as to whether the customer will be notified of the action taken by the carrier. This may be dependent on the particular action taken.

### Miscellaneous

The above infrastructure can be used to provide other exception handling, which may originate from the customer. Again, the possible conditions for this are varied, and cannot be exhaustively identified. For example, a consignor may initiate a shipment, and subsequently find out that certain events require the package to be returned to the consignor, for repackaging or replacement.

In such a situation, the consignor would typically communicate to the carrier the need to retrieve or intercept the package, while the package is in transit to the consignor. The communication from the consignor (or other party) to the carrier typically occurs via telephone or via electronic messaging (via email, or accessing a web-site). The consignor would identify themselves as the consignor (typically via a customer identifier number) and the package (which would be identified either by tracking number, or the date of shipment and other related information allowing the customer service representative to identify the package tracking number). The customer service representative would then be able to retrieve the customer profile and initiate a case log (if one is not already created). The customer service representative would obtain verbally from the consignor facts regarding the situation, and note these in the case log, and as well as any action to be taken by the carrier, which would including recording instructions to other carrier personnel accessing the case log. The system will typically automatically record the timestamp of the input provided, and the particular source of the information (e.g., a representative number or name). The PR system would store the information in the PR database. In one embodiment, the PR system would then indicate an exception condition associated with the package's PLD record in the PLD database. The exception condition could be a generic flag, or an indication specific to a PR condition.

In interacting with the customer, the customer service representative would generally confirm the status of the package first, namely that the package has not been delivered. (If delivered, the carrier does not have possession of the package, and would inform the caller of the situation.) Presuming the package is being processed by the carrier, the customer service representative would note where the package is in the delivery process. The PR system would facilitate retrieval of the appropriate personnel and their contact information for the current or scheduled locations of the package. For example, if the package is currently at the carrier's Pittsburgh sorting facility, the PR system would provide the name of the PR exception handling person (“PR personnel contact”) at the Pittsburgh sorting facility. The CSR could then contact the PR contact and leave a message indicating to be aware of the package. If the package is on the package delivery vehicle, the system would provide the appropriate address for communicating with the driver of the vehicle. At this point, the exact procedures to intercept the package may depend on the location of the package relative to the overall processing by the carrier.

Presumably, the above occurs as the package is in the carrier's processing infrastructure. Assume, for sake of illustration, that the package is on its way to Pittsburgh when the consignor initiates the intercept request to the CSR. As it arrives in the Pittsburgh facility, the package will be scanned (or otherwise read by a machine using other types of technology). The scanning process accesses the PLD database to ascertain its route, and in this case, the PLD database detects that a PR exception condition has been recorded. In response, the scanning equipment provides a suitable indication (i.e., a beep, visual warning indication, etc.) alerting the sorting personnel of the exception. The sorting personnel will set the package aside, and either access the case log, or bring the situation to the attention of the PR personnel contact. The PR personnel contact having been made aware of the situation recognizes the package as the aforementioned exception, and can act accordingly. While in the context of the “intercept” service, the appropriate action is to reroute the package back to the sender, in other contexts, the appropriate action may be to re-ice (e.g., temperature stabilize) the package. Other embodiments may simultaneous perform multiple actions; such as initiate an intercept action and issue recovery instructions.

It will be appreciated that many variations of the above systems and methods are possible, and that deviation from the above embodiments are possible, but yet within the scope of the claims. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for proactively managing intervention activities associated with the delivery of at least one package and the settlement of costs incurred thereby, said system comprising:
one or more memory storage areas containing:
(A) customer profile data comprising customer contact data for a customer associated with the delivery of said at least one package, intervention data regarding one or more actions to be taken by a service provider in response to a predefined condition associated with delivery of said at least one package, and insurance data regarding coverage of costs that may be incurred should said one or more actions be taken in response to said predefined condition;
(B) proactive monitoring data including information regarding status of said at least one package; and
(C) package level detail (“PLD”) data comprising a carrier tracking number of said package, and a proactive response secure (“PRS”) indication associated with said package; and
one or more computer processors configured to:
(A) receive new PLD data, said new PLD comprising at least an indication of a jeopardy delivery condition triggering said predefined condition associated with and impacting the delivery of said at least one package;
(B) determine and identify one of said one or more actions to be taken by said service provider in response to said jeopardy delivery condition, said determination and identification being based at least in part upon a portion of said intervention data;
(C) receive an indication of costs incurred due to said identified action being taken by said service provider; and
(D) in response to receiving said indication of costs incurred, determine an appropriate settlement procedure for said costs, said determination being based at least in part upon said insurance data.

2. The system of claim 1, wherein said one or more computer processors are further configured to:
determine whether said jeopardy delivery condition was caused by a delay-related incident or a non-delay related incident; and
wherein:
in response to said jeopardy delivery condition being delay-related, said appropriate settlement procedure facilitates settlement directly between said carrier and said service provider without involvement of said customer; and
in response to said jeopardy delivery condition being non-delay related, said appropriate settlement procedure facilitates reimbursement of said costs to said customer upon receipt of an insurance claim from said customer.

3. The system of claim 1, wherein said one or more computer processors are further configured to:
determine whether said jeopardy delivery condition was caused by a delay-related incident or a non-delay related incident;
in response to determining said jeopardy delivery condition was caused by a delay-related incident, identify said delay-related incident as a delay associated with a vehicle conveying the at least one package;
when identifying said identified action to be taken in view of said delay-related incident, identify said action as a rerouting of the at least one package via a third party air freight carrier; and
when determining said appropriate settlement procedure, identify such as a settlement directly between said carrier and said third party air freight carrier without involvement of said customer, said identification being based at least in part upon said insurance data.

4. The system of claim 1, wherein said one or more computer processors are further configured to:
determine whether said jeopardy delivery condition was caused by a delay-related incident or a non-delay related incident;
in response to determining said jeopardy delivery condition was caused by a non-delay-related incident, identify said delay-related incident as pertaining to the temperature of the at least one package during conveyance by a vehicle;
when identifying said identified action to be taken in view of said non-delay-related incident, identify said action as an action that pertains to temperature stabilization of the at least one package via services offered by a third party service provider; and
when determining said appropriate settlement procedure, identify such as a settlement between said customer and said third party service provider followed by submission of a reimbursement claim by said customer for processing based at least in part upon said insurance data.

5. The system of claim 4, wherein said action that pertains to temperature stabilization of the at least one package comprises at least one of dry ice replenishment or refrigeration of the at least one package.

6. The system of claim 1, wherein said one or more computer processors are further configured to, upon determining and identifying said at least one of said one or more actions to be taken by said service provider in response to said jeopardy delivery condition, further generate a notification indicating the identified action to be taken, the package tracking number, and a request for instructions.

7. The system of claim 6, wherein said notification further includes an indication of expected costs to be incurred upon taking said at least one identified action.

8. The system of claim 6, wherein two or more actions are identified and said request for instructions includes an option for a recipient of said notification to select a single one of said two or more action to be taken.

9. The system of claim 6, wherein said notification is transmitted to at least said customer and upon receipt of instructions from said customer, said one or more processors are configured to facilitate execution of said identified action by said service provider.

10. The system of claim 1, wherein said one or more computer processors are further configured to:
upon receiving an indication of costs incurred due to said identified action being taken by said service provider, generate a notification, said notification indicating the action taken, the package tracking number, and the costs incurred due to the action being taken;
determine whether said jeopardy delivery condition was caused by a delay-related incident or a non-delay related incident;
in response to said jeopardy delivery condition being delay-related, transmit said notification to said carrier and said service provider so as to facilitate settlement directly between said carrier and said service provider without involvement of said customer; and
in response to said jeopardy delivery condition being non-delay related, transmit said notification to said customer to facilitate reimbursement of said costs to said customer upon receipt of an insurance claim from said customer.

11. The system of claim 1, wherein said insurance data regarding coverage of costs that may be incurred is automatically generated and associated with said at least one package upon identification of said at least one package for proactive response status, said proactive response status being determined at least in part upon said customer profile data.

12. The system of claim 11, wherein said coverage of costs via said insurance data is automatically applied without said customer having to declare a value of any items within said at least one package.

13. The system of claim 1, wherein said one or more computer processors are further configured to generate one or more invoices for said proactive response and said secure insurance services, said services being identified as a single line item on said invoice.

14. The system of claim 13, wherein said services are applied against said customer profile data as a single flat rate, said single flat rate being independent from said actual costs incurred.

15. A computer-implemented method for proactively managing intervention activities associated with the delivery of at least one package and the settlement of costs incurred thereby, said method comprising the steps of:
(A) receiving and storing within one or more memory storage areas:
i. customer profile data comprising customer contact data for a customer associated with the delivery of said at least one package, intervention data regarding one or more actions to be taken by a service provider in response to a predefined condition associated with delivery of said at least one package, and insurance data regarding coverage of costs that may be incurred should said one or more actions be taken in response to said predefined condition;
ii. proactive monitoring data including information regarding status of said at least one package; and
iii. package level detail (“PLD”) data comprising a carrier tracking number of said package, and a proactive response secure (“PRS”) indication associated with said package; and
(B) receiving new PLD data, said new PLD comprising at least an indication of a jeopardy delivery condition triggering said predefined condition associated with and impacting the delivery of said at least one package;
(C) determining and identifying one of said one or more actions to be taken by said service provider in response to said jeopardy delivery condition, said determination and identification being based at least in part upon a portion of said intervention data;
(D) receiving an indication of costs incurred due to said identified action being taken by said service provider; and
(E) in response to receiving said indication of costs incurred, determining an appropriate settlement procedure for said costs, said determination being based at least in part upon said insurance data.

16. The computer-implemented method of claim 15, further comprising the steps of:
determining whether said jeopardy delivery condition was caused by a delay-related incident or a non-delay related incident;
in response to said jeopardy delivery condition being delay-related, facilitating settlement directly between said carrier and said service provider without involvement of said customer; and
in response to said jeopardy delivery condition being non-delay related, facilitating reimbursement of said costs to said customer upon receipt of an insurance claim from said customer.

17. The computer-implemented method of claim 15, further comprising the steps of:
upon determining and identifying said at least one of said one or more actions to be taken by said service provider in response to said jeopardy delivery condition, generating a notification, said notification indicating the identified action to be taken, the package tracking number, and a request for instructions;
transmitting said notification to at least said customer; and
upon receipt of instructions from said customer, facilitate execution of said identified action by said service provider.

18. The computer-implemented method of claim 15, further comprising the steps of:
upon receiving an indication of costs incurred due to said identified action being taken by said service provider, generating a notification, said notification indicating the action taken, the package tracking number, and the costs incurred due to the action being taken;
determining whether said jeopardy delivery condition was caused by a delay-related incident or a non-delay related incident;
in response to said jeopardy delivery condition being delay-related, transmitting said notification to said carrier and said service provider so as to facilitate settlement directly between said carrier and said service provider without involvement of said customer; and
in response to said jeopardy delivery condition being non-delay related, transmitting said notification to said customer to facilitate reimbursement of said costs to said customer upon receipt of an insurance claim from said customer.

19. The computer-implemented method of claim 15, further comprising the steps of:
receiving said insurance claim from said customer; and
facilitating processing of said insurance claim so as to complete reimbursement of said costs to said customer.

20. A non-transitory computer program product comprising at least one computer-readable storage medium having computer-readable program code portions embodied therein, the computer-readable program code portions comprising:
(A) a first executable portion configured for receiving a plurality of data, wherein said data comprises:
i. customer profile data comprising customer contact data for a customer associated with the delivery of said at least one package, intervention data regarding one or more actions to be taken by a service provider in response to a predefined condition associated with delivery of said at least one package, and insurance data regarding coverage of costs that may be incurred should said one or more actions be taken in response to said predefined condition;
ii. proactive monitoring data including information regarding status of said at least one package; and
iii. package level detail (“PLD”) data comprising a carrier tracking number of said package, a proactive response secure (“PRS”) indication associated with said package, and an indication of a jeopardy delivery condition triggering said predefined condition associated with and impacting the delivery of said at least one package; and
(B) a second executable portion configured for determining and identifying one of said one or more actions to be taken by said service provider in response to said jeopardy delivery condition, said determination and identification being based at least in part upon a portion of said intervention data; and
(C) a third executable portion configured for:
(i) receiving an indication of costs incurred due to said identified action being taken by said service provider; and
(ii) in response to receiving said indication of costs incurred, determining an appropriate settlement procedure for said costs, said determination being based at least in part upon said insurance data.
